(19) United States
(12) Patent Application Publication
(10) Pub. No.: US 2016/0087669 A1
(43) Pub. Date: Mar. 24, 2016

(54) DYNAMICALLY CHANGE THE CENTER OF GRAVITY OF A TABLET

(71) Applicant: QUALCOMM Incorporated, San Diego, CA (US)

(72) Inventor: Jaemin Kang, Seoul (KR)

(21) Appl. No.: 14/490,570

(22) Filed: Sep. 18, 2014

(51) Int. Cl. H04B 1/3888

(52) U.S. Cl. CPC H04B 1/3888

(57) ABSTRACT

Systems and methods are described for reducing a felt weight of a mobile device, for example, by providing an apparatus in the mobile device, the apparatus comprising: a component collection having at least one selected hardware component of the mobile device. The apparatus further includes a sensor configured to provide a signal corresponding to a position on the mobile device where a user would grip the mobile device. The component collection is configured for movement within an interior volume of a casing of the mobile device based, at least in part, on the signal provided by the sensor.

### BACKGROUND

1. Field

Embodiments described herein generally relate to reducing perceived weight felt by a user of a mobile device, and more specifically, to shifting the center of mass of the mobile device for reducing the perceived weight felt by the user of the mobile device.

2. Background

As mobile devices, such as smart phones, tablet computers, and laptop computers gain popularity, a need is felt to reduce perceived weight felt by users of the mobile devices. A felt weight of the mobile device may refer to a weight of the mobile device as felt or otherwise perceived by a user of the mobile device who is gripping the mobile device. Typically, the weight felt by the users may be reduced by reducing the weight and sizes of each hardware component of the mobile devices. For example, the size and weight of battery pack, motherboard, processor, memory devices, and the like can be reduced to decrease the overall weight of the device. As the overall weight of the mobile devices is reduced, the felt weight of the mobile devices is accordingly reduced.

However, a large percentage of the weight of the mobile device originate from the display screen of the mobile device. While it is preferable to reduce the size of other hardware components (e.g., the battery pack, motherboard, processor, memory devices, and the like), it may not be preferable to reduce the size of the display screen. This is because the size of the display screen may be set for various purposes such as readability, resolution, viewing convenience, entertainment value, color, distance to viewer, and/or the like. In addition, a casing of the mobile device enclosing the display screen may also add additional weight to the mobile device.

Accordingly, reducing the felt weight by reducing the weight and size of the hardware components has limitations. Alternative or additional methods are needed to further reduce the felt weight of the mobile devices.

### SUMMARY

Embodiments described herein generally relate to shifting a center of mass of a mobile device by configuring hardware components for movement within the mobile device. Various hardware components (e.g., selected hardware components) may be arranged within a component collection, and moved according to as described as a single module. The mobile device may sense a touch location where a user is gripping the mobile device, and move the component collection to the touch location.

Various embodiments relate to an apparatus in a mobile device, the apparatus including, but not limited to, a component collection having at least one selected hardware component of the mobile device and a sensor configured to provide a signal corresponding to a position on the mobile device where a user would grip the mobile device. The component collection is configured for movement within an interior volume of a casing of the mobile device based, at least in part, on the signal provided by the sensor.

In some embodiments, the at least one selected hardware component includes, but not limited to, at least one of: a processor, memory device, battery, wireless radio, or printed circuit board (PCB).

According to some embodiments, at least one damper is coupled to the component collection. The damper is configured to decelerate and stabilize motion of the component collection.

In various embodiments, each of the at least one damper includes at least one of a spring, high-friction surface, string, or stopper.

In some embodiments, the sensor includes at least one of a gravity sensor, heat sensor, display screen, or accelerometer.

In various embodiments, the apparatus further includes a displacement device. The displacement device is configured to move the component collection in response to the signal provided by the sensor.

In some embodiments, the displacement device includes at least one of a rack and pinion system or solenoid system.

In some embodiments, the displacement device actively drives the component collection with at least one motor. In various embodiments, the component collection is supported within the casing for movement by gravity.

According to some embodiments, the component collection is supported in the casing for movement in a first direction along a first axis. The component collection is supported in the casing for movement in a second direction along a second axis. The second axis is perpendicular to the first axis.

In some embodiments, the component collection is supported in the casing for movement in a third direction along a third axis. The third axis is perpendicular to both the first axis and the second axis.

Embodiments described related to a mobile device including, but not limited to: a casing defining an interior volume, a component collection having at least one selected hardware component of the mobile device, a displacement device configured to move, with respect to the casing of the mobile device, the component collection to a point of contact. The point of contact corresponds to where a user would grip the mobile device. The mobile device further includes at least one fixed hardware component. The at least one fixed hardware component is fixed with respect to the casing.

In some embodiments, the mobile device further includes a display screen and an outer back shell arranged opposite to the display screen. The component collection is configured to move between the display screen and the outer back shell.

In some embodiments, the at least one selected hardware component is connected to the at least one fixed hardware component and the display screen with at least one cable.

In various embodiments, the component collection is supported within the casing for movement by gravity.

According to some embodiments, the displacement device may be configured to support moving of the component collection to a bottom portion of the mobile device.

The mobile device further includes a sensor configured to output a signal corresponding to the point of contact. The displacement device is configured to move the component collection in response to the signal.

According to various embodiments, methods for reducing a felt weight of a mobile device may be described, the method including, but not limited to: determining, with a processor of the mobile device, a first target position. The first target position is where a user would grip the mobile device. The methods further includes configuring a component collection to move within an interior volume of the mobile device to the first target position.

The methods further includes providing the component collection having at least one selected hardware component. The selected hardware component includes a battery.

In some embodiments, the component collection is configured to move based on information detected by at least one sensor. The at least one sensor includes at least one of a gravity sensor, heat sensor, display screen, or accelerometer.

### BRIEF DESCRIPTION OF THE DRAWINGS

FIG. 1 is a functional block diagram of a mobile device suitable for implementing various embodiments.

FIG. 2A is a schematic diagram of an example of a top view of a felt weight reduction system according to various embodiments.

FIG. 2B is a schematic diagram of an example of a side view of the felt weight reduction system according to various embodiments.

FIG. 3A is a schematic diagram of another example of a top view of the felt weight reduction system according to various embodiments.

FIG. 3B is a schematic diagram of another example of a side view of the felt weight reduction system according to various embodiments.

FIG. 4 is a schematic diagram of yet another example of the felt weight reduction system according to various embodiments.

FIG. 5A is a schematic diagram of an example of a side view of a component collection according to various embodiments.

FIG. 5B is a schematic diagram of an example of a top view of a component collection according to various embodiments.

FIG. 6 is a process flowchart illustrating a process for moving a center of mass of a mobile device according to various embodiments.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the invention or the claim.

As tablets and other handheld mobile devices increase in popularity, user experience may be improved by reducing the weight felt by the user of such devices. Embodiments described herein generally relate to reducing the weight felt by the user of a mobile device, for example, by shifting the center of mass of the mobile device. When the center of mass of the mobile device is closer to a position where the user is holding the mobile device, the felt weight of the mobile device is reduced. Thus, portability and comfort are improved, leading to improvement to overall user experience.

As used herein, a mobile device refers to a handheld electronic device such as, but not limited to, a cellular telephone, smart phone, personal or mobile multi-media player, personal data assistant, laptop computer, personal computers, tablet computer, smart book, palm-top computer, wireless electronic mail receiver, multimedia Internet-enabled cellular telephone, wireless gaming controller, and the like. In addition, various other electronic devices may benefit from the embodiments described without deviating from the spirit of the disclosure.

Each mobile device is associated with a felt weight (i.e., a weight of the mobile device as felt or perceived by a user of the mobile device who is gripping the mobile device). Embodiments described seek to dynamically shift a center of mass of the mobile device to reduce the felt weight of the mobile device, even if the actual weight of the mobile device is not reduced. The center of mass of a typical mobile device may approximately be in the center of the device. The center of mass of a mobile device may be dependent on the position of hardware components of the mobile device. In particular, the position of heavier hardware components (e.g., the battery pack, a circuit board, and/or the like) may play a bigger role in influencing the center of mass of the mobile device.

The farther the center of mass is from a point of contact (the point at which the user is gripping/holding the mobile device), the heavier the mobile device would feel to the user. Thus, to move the center of mass toward the point of contact would reduce the felt weight of the mobile device.

As hardware components of the mobile device become smaller in size while display screen sizes are kept the same or enlarged for user experience, an empty space may be provided between the display screen and an outer back shell of the mobile device. According to embodiments described, the empty space enables at least some of the hardware components of the mobile device to be physically moved within the mobile device's casing. In some embodiments, various hardware components are selected (e.g., referred to herein as “selected hardware components”) to be received in a component collection. The component collection is configured to move (e.g., with the selected hardware components received on or inside the component collection) within the mobile device. Other hardware components not received in the component collection may remain in a fixed position. These other hardware components may be hardware components fixed to the casing of the mobile device such as, but not limited to, speakers, microphones, headphone jacks, image/video cameras, various sensors, user interactive elements, buttons, knobs, sliders, dials, related components thereto, and/or the like. As such, the component collection may enable the selected hardware components to move toward the point of contact, thus reducing the felt weight. In particular embodiments, the heavier hardware components (e.g., the battery pack, the printed circuit board, and/or the like) may be selected (as the selected hardware components) to be received in the component collection while the lighter hardware components may remain fixed.

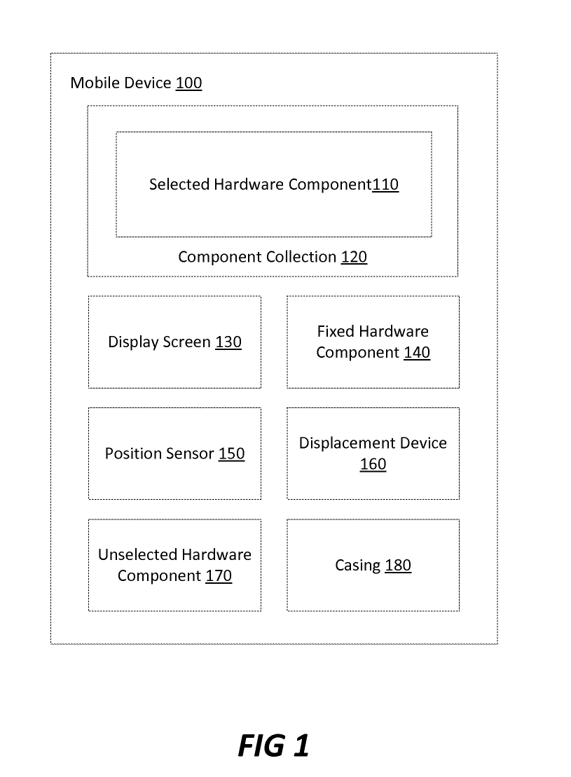

With reference to FIG. 1, illustrated is a functional block diagram of a mobile device 100 suitable for implementing various embodiments. The mobile device 100 includes a component collection 120, display screen 130, fixed hardware component 140, position sensor 150, displacement device 160, unselected hardware component 170, casing 180, and/or the like. In some embodiments, the component collection 120 may be configured to receive at least one selected hardware component 110. In further embodiments, one or more of the display screen 130, fixed hardware component 140, position sensor 150, displacement device 160, and unselected hardware component 170 may be omitted.

The display screen 130 may be any suitable graphic displaying device that can provide a human-perceptible visible signal, audible signal, tactile signal, or any combination thereof, including, but not limited to a touchscreen, LCD, LED, CRT, plasma, or other suitable display screens. In various embodiments, a user input device may be coupled to the display screen 130. The user input device include any suitable device that receives input from the user. The user input device including, but not limited to one or more manual operator (such as, but not limited to a switch, button, touchscreen, knob, slider or the like), microphone, camera, image sensor, touchscreen display, and the like. In a specific non-limiting example, the display screen 130 may include at least a touch interface for receiving the user input and a display device for displaying graphics. In various mobile devices such as the mobile device 100, the display screen 130 may substantially occupy at least one surface of the mobile device 100.

In some embodiments, the casing 180 may be a housing or outer shell of the mobile device 100. The casing 180 may be configured to enclose the hardware components of the mobile device 100. In particular, the casing 180 may be configured to enclose, at least partially, the selected hardware component 110, the component collection 120, the fixed hardware component 140, the position sensor 150, the displacement device 160, the unselected hardware component 170, and/or the like. The displace screen 130 may be coupled or otherwise supported by the casing 180. The casing 180 may define an interior volume, where the hardware components may be received. In some embodiments, the component collection 120 may be configured to move within the interior volume defined by the casing 180.

In some embodiments, the component collection 120 may be a compact casing, box, platform, plate or other suitable structure for receiving and retaining at least one selected hardware component 110. The selected hardware component 110 may refer to at least one hardware component of the mobile device 100. In various embodiments, the selected hardware component 110 does not include the display screen 130. In further embodiments, the selected hardware component 110 does not include at least one fixed hardware component 140 and/or the unselected hardware component 170.

According to various embodiments, two or more component collections 120 may be included in the mobile device 100. The two or more component collections 120 may each include different hardware components (e.g., a different selected hardware component 110). Each of the two or more component collections 120 may be configured to move within the interior volume defined by the casing 180. The two or more component collections 120 may move along or parallel to a same axis, or the two or more component collections 120 may be arranged to move along or parallel to different axes that may be perpendicular to each other.

The fixed hardware component 140 may be any hardware components fixed to the casing of the mobile device 100. The fixed hardware component 140 may be at least one of a speaker, microphone, headphone jacks, image camera, video camera, user interactive element, button, knob, slider, dial, related components (modules) thereto, a combination thereof, and/or the like. In addition, the fixed hardware component 140 may include additional modules attached to the hardware components for receiving additional electronics related to the fixed hardware component 140. These additional modules may also be fixed to the casing of the mobile device 100. For example, the image camera and/or video camera and each include a camera module attached thereto. The microphone, headphone jack, and speaker may also be associated with corresponding modules. The user interactive element, the button, the knob, the slider, and the dial, may similarly be associated with corresponding modules. In further embodiments, the fixed hardware component 140 may include a touch screen controller module associated with the display screen 130. In other embodiments, the modules may be selected as the selected hardware components 110 and configured for movement. By allowing as much hardware components to be received in the component collection 120 as possible, more felt weight may be reduced as more weight is being shifted.

The fixed hardware component 140, the unselected hardware component 170, and the display screen 130 may be connected to the component collection 120 through suitable securing members such as, but not limited to, electrical wires/cables, flexible wires/cables, various wireless network (e.g., a BlueTooth network) a combination thereof, and/or the like. In some embodiments, the wires/cables may be flexible and/or extendible, such that fixed hardware component 140, the unselected hardware component 170, and the display screen 130 may remain linked or connected by the wires/cables in all possible positions that the component collection 120 may be moved to. The component collection 120 may include additional wiring or transmission platforms to connect the data/signal received from fixed hardware component 140, the unselected hardware component 170, and the display screen 130 to the selected hardware component 110.

For example, the component collection 120 may include one or more hubs located at an edge or outer peripheral portion of the component collection 120 to receive wires/cables carrying data/signal to or from the fixed hardware component 140, the unselected hardware component 170, and the display screen 130. The hub may be connected to a circuit board through any suitable connection for communicating the data/signal. The hub may also be connected to at least one selected hardware component 110 directly. In other embodiments, the component collection 120 may include at least one recess, aperture, and/or through hole for allowing the wires/cables from the fixed hardware component 140, the unselected hardware component 170, and the display screen 130 to be connected to the selected hardware component 110.

In some embodiments, the selected hardware component 110 may be at least one processor, memory device, battery pack, antenna, Wi-Fi radio, Bluetooth radio, printed circuit board (PCB) for receiving various hardware components, and/or the like. The PCB may be one or more of a main logic board, input-output PCB, network PCB, motherboard, special-function PCB, a combination thereof, and/or the like. The PCB may include one or more of hardware controller, driver, processor, filter, switch, oscillator, memory, multiplexer, Mux/De-Mux, codec, actuator, various sensors (e.g., accelerometer, gravity sensor, heat sensor, gyroscope, compass, pressure sensor, proximity sensor, image sensor and/or the like), expander, power management unit, power converter, various semiconductors, integrated circuit components, microchips, microelectromechanical systems (MEMS) device, network resources, a combination thereof, and/or the like.

In particular, the at least one processor may include any suitable data processing device, such as a general-purpose processor (e.g., a microprocessor). In the alternative, the processor may be any suitable electronic processor, controller, microcontroller, or state machine. The processor may also be implemented as a combination of computing devices (e.g., a combination of a DSP and a microprocessor, a plurality of microprocessors, at least one microprocessors in conjunction with a DSP core, or any other such configuration). The at least one memory device may be operatively coupled to the processor and may include any suitable internal or external device for storing software and data for controlling and use by the processor to perform operations and functions described herein, including, but not limited to, random access memory RAM, read only memory ROM, floppy disks, hard disks, dongles or other USB connected memory devices, or the like. The memory device may store an operating system (OS), as well as user application software and executable instructions. The memory may also store application data, such as an array data structure.

In various embodiments, a hardware component that is not the display screen 130 and/or not the fixed hardware component 140 may be a selectable hardware component (i.e., a hardware component that may be included as a selected hardware component 110). A hardware component that is included and received in the component collection 120 becomes a selected hardware component 110. On the other hand, a hardware component that is not included and received in the component collection 120, may be an unselected hardware component 170. In particular embodiments, the mobile device 100 may include at least one unselected hardware component 170. The unselected hardware component 170 is not included in the component collection 120 and, thus, is fixed to a static location with respect to the casing of the mobile device 100.

In some embodiments, all hardware in the casing and that is not the display screen 130 and/or not the fixed hardware component 140 is the selected hardware component 110 and is configured for movement within and with respect to the mobile device 100. Accordingly, in some embodiments, there are no unselected hardware components 170. In other embodiments, some but not all hardware in the casing and that is not the display screen 130 and/or not the fixed hardware component 140 are the selected hardware components 110. The selected hardware components 110 may be selected based on size, weight, resistance to damage, or other criteria, for example, such that one or more selected hardware components 110 may fit into the component collection 120 of a given size, contribute sufficiently to the weight of the component collection 120, avoid damage from movement of the component collection 120 or the like.

In various embodiments, the heavier selectable hardware component may be received in the component collection 120. Each of the selectable hardware components may be ordered according to a weight associated with the selectable hardware component. At least a number of heaviest hardware components may be received in the component collection 120 as the selected hardware component 110. Other selectable hardware components may be selected depending on the space remaining in the component collection 120. In a non-limiting example, at least the battery pack may be received in the component collection 120 as a selected hardware component 110. Other additional hardware components may or may not be received in the component collection 120 other than the battery pack. In another non-limiting example, the battery pack and at least one PCB may be received in the component collection 120. By shifting the heavier (e.g., some of the heaviest hardware components such as the battery pack, the PCBs, and/or the like) within the mobile device 100, more felt weight is reduced.

Each selected hardware component 110 may be secured to the component collection 120 through various securing members. In some embodiments, some selected hardware components 110 may be may be received on at least one PCB. The PCB may then be secured onto a receiving surface of the component collection 120 by nails, screws, glues, plugs, soldering, and/or the like. The battery pack may be secured directly to the component collection 120. Alternatively, at least a portion of the battery pack may be secured on the PCB, while the rest of the battery pack may be secured directly on the receiving surface of the component collection 120.

In other embodiments, at least a portion/compartment of the component collection 120 may be a plated or encased PCB. Two or more PCBs may be joined on a same circuit board, forming a same PCB. In a non-limiting example, a PCB including the main logic board, the input-output PCB, and the network PCB may be received in one compartment of the component collection 120. The battery pack may be received in another compartment of the component collection 120. The compartments may be divided at least partially by walls extending from a base plate of the component collection 120. The compartments of the same component collection 120 may be configured to move together as a unit (e.g., by the displacement device 160). Accordingly, each selected hardware component 110 received or otherwise secured in the component collection 120 may be moved together (e.g., by the displacement device 160).

The position sensor 150 may be configured to sense at least one point of contact. The position sensor 150 may be a gravity sensor, heat sensor, the display screen 130, accelerometer, gyroscope, a combination thereof, and/or the like. In typical embodiments, the position sensor 150 may output raw data (e.g., in the form of signals), which may be processed by a processor of the mobile device 100 to approximate or extract the point of contact. The user may grip the mobile device 100 in an area including on outer surface(s), side(s), or corner(s) of the mobile device 100. Accordingly, in some cases, the point of contact may be determined (e.g., by the processor of the mobile device 100) to be along at least one surface of the mobile device 100 or proximal to a corner of the mobile device 100. The point of contact may be located at any position on the outer surface of the mobile device 100 and approximated with a position within the casing of the mobile device 100. In various embodiments, the position sensor 150 may be fixed (i.e., not configured for movement with respect to the casing of the mobile device 100) to assure accuracy of sensor output.

In some embodiments, the position sensor 150 may be a gravity sensor sensing the side(s) or corner of the mobile device 100 that is the closest to the ground when being held in an upright position by a user. This point of contact approximation method corresponds to a general trend among mobile device users to grip the mobile device at a bottom half portion of the mobile device 100. It may be assumed that that the point of contact is approximately at the bottom of the device (as determined by the gravity sensor), when the mobile device 100 is held upright (e.g., in a typical viewing position). The upright position may include a plurality of different orientations of the mobile device 100 as the user uses the mobile device 100. In other words, the gravity sensor senses the gravitational force of each dimension of the mobile device 100 and determines which side(s) and/or corners of the mobile device 100 may experience the greatest gravitational force. The gravity sensor may output data representing a vector pointing at side(s) and/or a corner of the mobile device 100 associated with a lowest point of the mobile device 100. Accordingly, the point of contact is approximated by the side, surface, and/or corner associated with the lowest point of the mobile device 100 as identified by the gravity sensor.

In various embodiments, the position sensor 150 may be at least one heat sensor (e.g., a thermometer, thermocouples, resistive temperature devices, infrared heat sensor, bimetallic devices, liquid heat sensors, diodes, and/or the like). For example, various heat sensors may be distributed (e.g., evenly or around the outer surfaces/sides of the mobile device 100) within the mobile device 100. Each heat sensor may detect the amount of heat associated with that heat sensor and output data values representing the amount of heat detected. For example, output data values representing the amount of heat detected may be sent to the processor. The processor may determine at least one heat sensor that has detected the most amount of heat by comparing the output data values received. The point of contact may then be associated with the at least one heat sensor that as detected the most amount of heat out of the various heat sensors. In a non-limiting example, the point of contact may be determined (e.g., by the processor of the mobile device) to be the position of the heat sensor detecting the most amount of heat. In another non-limiting example, the point of contact may be defined along an edge or corner of the surface in the volume associated with the heat sensor (e.g., the heat sensor may be configured to sense heat within the volume). The processor of the mobile device 100 may be configured to calculate a midpoint as the point of contact when two or more heat sensors are sensing the same or similar amount of heat.

In other embodiments, a sheet heat sensor may be installed in the mobile device 100 for sensing heat distribution of the mobile device 100. When the user grips the mobile device 100 at a gripping area, the heat signature of the mobile device 100 may change given that the gripping hand is increasing the temperature of the gripping area. Such data may be sent to the processor of the mobile device 100. In response to an increase in temperature exceeding a predetermined rate (e.g., at least 1° C./5 s, 0.5° C./5 s, 1° C./20 s, and/or the like) or exceeding a threshold temperature (e.g., 37° C., which is the human body temperature, 35° C., 33° C., and/or the like), the point of contact may be defined at the gripping area. The point of contact may be defined by the processor to be a center (or an approximate center) of the gripping area.

In some embodiments, the position sensor 150 may be a display screen 130, where the display screen 130 may be a touch screen for receiving user's touch as input. The user of the mobile device 100 may keep a part of his/her hand on the display screen 130 while gripping the mobile device 100, given that the edge surfaces surrounding the display screen 130 may be narrow. In some embodiments, when the display screen 130 may detect that the user has been touching a same location of the display screen 130 for a predetermined period of time (e.g., 5 s, 7.5 s, 10 s, and/or the like), the processor of the mobile device 100 may determine the point of contact to be where the touch location is.

In some embodiments, the point of contact may be defined by user input. In particular, the mobile device 100 may be configured to receive input (e.g., from the display screen 130 and/or other suitable input devices described) from the user, specifying preferred positions to hold the mobile device 100. For example, when the mobile device 100 is powered on and in an active mode (e.g., the mobile device 100 is activated engaged by the user and not in a standby mode in which the user does not interact with the mobile device 100), the user may be prompted to selected a preferred gripping position. For example, the user may be prompted to tap a touch location on the display screen 130 to indicate a position closest to where the user grips or intends to grip the mobile device 100. The touch location (as received as a user input) may then be determined by the processor of the mobile device 100 to be the point of contact.

In various embodiments, the component collection 120 may be configured for movement, the movement being guided or driven by gravity (e.g., in a passive manner, without added electrical or mechanically added drive force). That is, the component collection 120 may be configured to move toward a lowest point of the mobile device 100 (point on the mobile device 100 closest to ground when the mobile device 100 is held in an upright orientation by the user) due to gravity. In these embodiments, it is assumed that that the point of contact is approximately at the bottom of the device when the mobile device 100 is held upright. In other words, the component collection 120 is configured for free movement within the casing of the mobile device 100 subject to limitations of the displacement device 160, the physical dimensions of the free space within which the component collection 120 is configured to move (e.g., spaces occupied by display screen 130, the fixed hardware component 140, the unselected hardware component device 170, and/or the like), and other limitations inherent to the mobile device 100. Thus, no additional sensors may be implemented, as the component collection 120 may move in response to gravitational pull.

In further embodiments, dampers may be provided to restrict a complete free motion of the component collection 120 to prevent undesired movement of the component collection 120. For example, dampers may be provided to cause the component collection 120 to decelerate/stabilize the movement of the component collection 120. This may reduce the impact of undesired movement by preventing the component collection 120 from moving rapidly in response to any minor/short-lived motion other than gravity. In other embodiments, a sensor (e.g., an accelerometer) may be provided to sense accelerations of the mobile device 100 in various directions. The displacement device 160 may be configured to prevent the component collection 120 from moving in any direction of acceleration that is not due to gravity. The processor of the mobile device 100 may determine a direction due to gravitational acceleration (e.g., as determined by the gravity sensor or the natural tendency of the component collection 120 from moving in response to gravity). The movement in directions other than the direction due to gravitational acceleration may not be permitted.

The displacement device 160 may be any suitable device for mechanically moving the component collection 120 and the selected hardware component 110 received therein within the casing of the mobile device. The displacement device 160 may include a driving system which drives the component collection 120 toward the point of contact as sensed by the position sensor 150 (or approximated by gravity without sensors). Suitable implementations of the displacement device 160 include a motor, a rack/pinion system, solenoid/rod system, gravity (passive driving system), a combination thereof, and/or the like. An electric motor may be fixed to the casing of the mobile device 100. The electric motor may alternatively be fixed to the component collection 120 and movable with the component collection 120.

In particular embodiments, the electric motor may be driving a rack/pinion system. At least one rack may be arranged within the casing of the mobile device 100. In some embodiments, a rack is arranged along a central axis (e.g., an axis along a longitudinal dimension of the housing) of the mobile device 100. In other embodiments, a first rack is arranged along a side surface of the mobile device 100. In further embodiments, a secondary rack (in addition to the first rack) may be arranged along an opposite side surface of the mobile device 100 along a parallel axis. This is so that the movement of the component collection 120 may be supported by racks along both side surfaces of the mobile device 100. Accordingly, the component collection 120 may be configured to move along a first axis (e.g., the central axis and/or the axis along the side surfaces) of the mobile device 100. Thus, the component collection 120 may be configured to move along a 1-dimensional space.

The component collection 120 may include a pinion coupled to a side, bottom, or top surface of the component collection 120. The pinion may be driven by an electric motor coupled to the component collection 120. In addition, a receiving module may be coupled to the electric motor for receiving instructions (e.g., from a processor received in the component collection 120) for moving the electric motor. Whereas the component collection 120 is driven by gravity only, the pinion may not need to be coupled to any electric motor, as the component collection 120 is driven by gravity.

In further embodiments, the rack/pinion system may include additional rack(s) arranged in or parallel to a second axis perpendicular to the first axis in the manner described with respect to the rack(s) arranged along or parallel to the first axis. Accordingly, the component collection 120 may be configured to move along a 2-dimensional space. In still further embodiments, the rack/pinion system may include still additional rack(s) arranged in or parallel to a third axis perpendicular to both the first axis and the second axis in the manner described with respect to the rack(s) arranged along or parallel to the first and second axis. Accordingly, the component collection 120 may be configured to move along a 3-dimensional space. For each rack (in the 1-dimensional, 2-dimensional, and/or 3-dimensional configurations as described), a pinion of the component collection 120 may be coupled the rack for movement. Similarly, the pinions may be driven by electric motors in response of sensor data. The pinions may alternatively be driven by gravity (e.g., without aid from any motors).

With respect to the 2-dimensional configuration, the component collection 120 may be coupled to the rack(s) extending along or parallel to the first axis (e.g., through at least one pinion). The rack(s) extending along or parallel to the first axis may be coupled to rack(s) extending along or parallel to the second axis. Accordingly, the component collection 120 may form a primary module with the rack(s) extending along or parallel to the first axis, such that the rack(s) extending along or parallel to the second axis may move the entire primary module including the racks(s) associated with the first axis and the component collection 120 together.

With respect to the 3-dimensional configuration, the component collection 120 may be coupled to the rack(s) extending along or parallel to the first axis (e.g., through at least one pinion). The rack(s) extending along or parallel to the first axis may be coupled to rack(s) extending along or parallel to the second axis. The rack(s) extending along or parallel to the second axis may, in turn, be coupled to rack(s) extending along or parallel to the third axis. Accordingly, the component collection 120 may form a primary module with the rack(s) associated with the first axis. The primary module, in turn, may form a secondary module with the rack(s) associated with the second axis. The rack(s) associated with the third axis may move the entire secondary module including the component collection 120 and the racks(s) associated with both the first and the second axis together. The rack(s) associated with the second axis may move the entire primary module including the component collection 120 and the racks(s) associated with the first axis. The rack(s) associated with the first axis may move the component collection 120. The component collection 120 may move along the rack(s) extending along the different one of the first axis, the second axis, and/or the third axis simultaneously or sequentially in any suitable order.

A solenoid/rod system may be implemented in various embodiments for moving the component collection 120 as the displacement device 160. In some embodiments, at least a rod may be arranged in the first axis of the mobile device 100. A solenoid may be coupled to the component collection 120. The component collection 120 may include current supplies such as a current source for passing current to the solenoid. The solenoid may then be configured to move along the rod based on the applied current.

Similarly, additional rod(s) may be arranged along or parallel to the second axis perpendicular to the first axis for moving the component collection 120 in a 2-dimensional space. Further addition rod(s) may be arranged along or parallel to the third axis perpendicular to both the first axis and the second axis for moving the component collection 120 in a 3-dimensional space.

In various embodiments, the component collection 120 may be configured to be moved by gravity by configuring the component collection 120 to move passively due to gravity. For example, the component collection 120 may be configured to be supported by racks and pinions as described, the rack/pinion system need not be actively driven by a motor or other active drivers. Similarly, the other suitable systems may not be actively driven by a motor or other active drivers. The rack/pinion system, the solenoid/rod system, and other suitable systems may be moved in response to and/or based on data outputted the position sensor 150. Alternatively, the various systems may not be required to move in response to and/or based on data outputted the position sensor 150 when the component collection 120 is entirely driven by gravity.

In some embodiments, dampers may be provided to the component collection 120 and/or the displacement device 160 to damp the movement of the component collection 120. The dampers may prevent the selected hardware component 110 from being damaged form the movement of the component collection 120. Additionally, the dampers may prevent damages to the displace screen 130, the fixed hardware component 140, the position sensor 150, the displacement device 160, and unselected hardware component 170 potentially caused by the movement of the component collection 120. In some embodiments, walls may be provided within the casing of the mobile device 100 for compartmentalizing the fixed hardware component 140, the position sensor 150, the displacement device 160, unselected hardware component 170, and the space configured for the movement of the component collection 120.

For example, cushions made of flexible and/or compressible materials may be provided on the component collection 120 and/or the walls for damping the impact of the component collection 120. Examples of the cushions include various rubber, foam, springs, a combination thereof, and/or the like.

In some embodiments, dampers may be provided to the racks and pinions to dampen (e.g., to slow) the movement of the component collection 120. The dampers include springs, high-friction surfaces, strings, stoppers, a combination thereof, and/or the like.

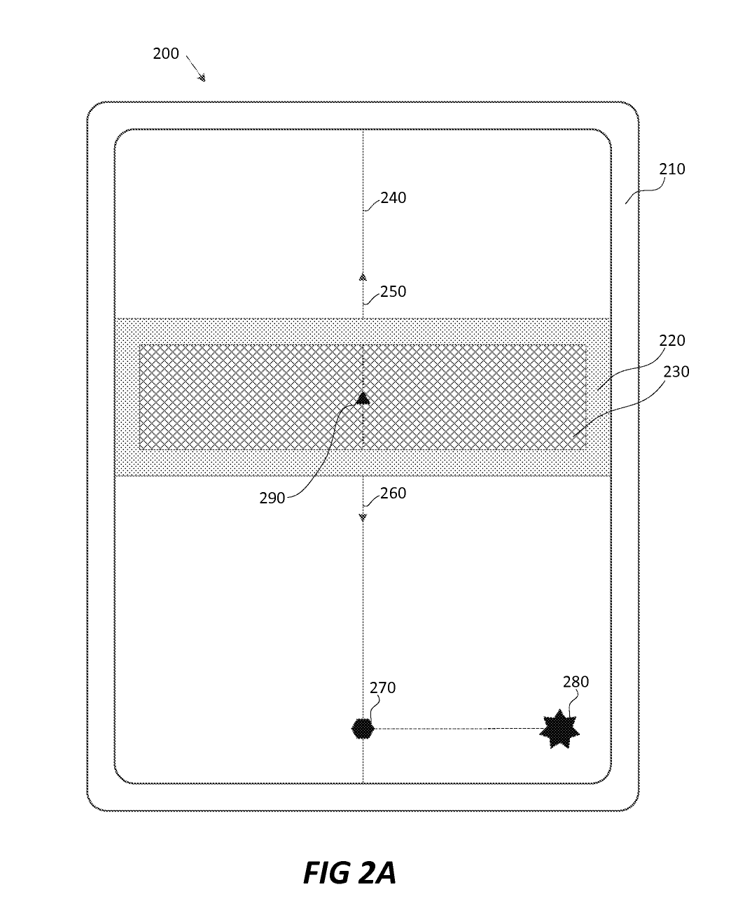

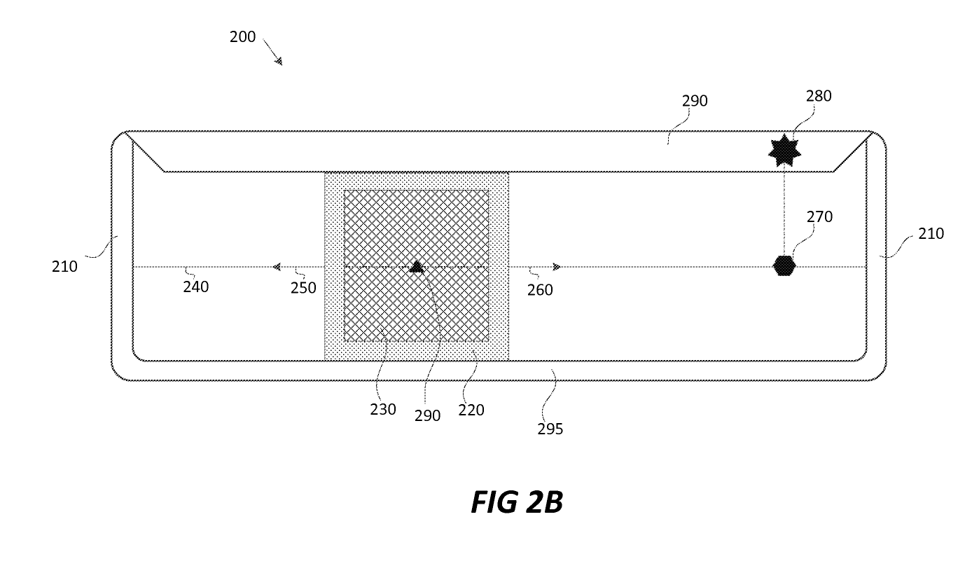

FIG. 2A is a schematic diagram of an example of the felt weight reduction system according to various embodiments. Now referring to FIGS. 1-2A, FIG. 2A illustrates a 1-dimensional implementation of the felt weight reduction system as viewed from a front surface (e.g., from the screen display 130) of a mobile device 200. An example of a component collection 220 (e.g., such as, but not limited to, the component collection 120) may be provided to receive selected hardware component 110 in the component receiving space 230. The component collection 220 may be arranged within sidewalls 210 of the mobile device 200 (e.g., such as, but not limited to, the mobile device 100).

The component collection 220 may be configured for moving along or parallel to a first axis 240, for example, in either a first direction 250 or a second direction 260. The first direction 250 and the second direction 260 may be opposite directions.

The first axis may be an imaginary axis of the mobile device 200 or a physic axis as defined by a rack or rod of the displacement device 160. In some embodiments, the first axis 240 may be parallel to at least a sidewall of the sidewalls 210. In various embodiments, the direction in which the component collection 220 moves is determined based on the point of contact 280 as determined by the position sensor 150 in the manner described. The component collection 220 may initially be in an initial position 290. The initial position 290 may be a position on the first axis 240 that corresponds to the position of the component collection 220.

In some embodiments, the position sensor 150 may determine that the user is gripping the mobile device 200 at the point of contact 280. The processor of the mobile device 200 may be configured to determine a corresponding target position 270 based on the point of contact 280. For example, in a 1-dimensional case such as illustrated by FIG. 2A, the target position 270 corresponding to the point of contact 280 may be a coordinate on the first axis 240. The target position 270 being reached by a line originating from the point of contact 280, the line being perpendicular to the first axis 240. The target position 270 may be adjusted according to the dimensions of the component collection 220. For example, where the target position 270 is too close to the sidewalls 210 for the component collection 220 to move, the target position 270 may be adjusted to be a point further along the first axis 240 from the sidewalls 210.

The processor of the mobile device 200, which may be received within the receiving space 230, may determine a direction of motion, a distance, velocity, and/or the like of the component collection 220. The direction of motion, the distance, the velocity, and/or the like may be determined based on the target position 270 and the initial position 290. In the non-limiting example illustrated in FIG. 2A, the direction of motion may be the second direction 260.

FIG. 2B is a schematic diagram of an example of the felt weight reduction system according to various embodiments. In particular, FIG. 2B illustrates a 1-dimensional implementation of the felt weight reduction system as viewed from a side surface of the mobile device 200. The diagram of FIG. 2B may present a side view of the system as presented by FIG. 2A. Now referring to FIGS. 1-2B, the felt weight reduction system illustrated may include the component collection 220 to receive selected hardware component 110 in the component receiving space 230 in the manner described. The component collection 220 may be arranged between the display screen 290 (e.g., such as, but not limited to, the display screen 130) and an outer back shell 295 of the mobile device 200. The outer back shell 295 may be coupled to or continuous with respect to the sidewalls 210. The component collection 220 may be configured to move along the first axis 240 in a first direction 250 or a second direction 260. The component collection 220 may be in the initial position 290.

Similar to described herein, the point of contact 280 may be determined by the processor of the mobile device 200 based on data outputted from the position sensor 150. A corresponding target position 270 may be determined by the processor of the mobile device 200. The component collection 220 may be configured to move in the second direction 260 as shown in FIG. 2B.

In various embodiments, the initial position 290 of the component collection 220 may be in the center of the first axis 240. The position of the component collection 220 may be reset to the center of the first axis 240 when the mobile device 200 is powered down and/or when it enters an idle mode (e.g., in a screen-locked and/or screen-off mode) in which the mobile device 200 is not being actively used by the user. The initial position 290 of the component collection 220 may be in the center of the first axis 240 when the mobile device 200 is powered on, transitions an active mode from an idle mode, and/or the like. In other embodiments, the initial position 290 may be a position other than the center of the first axis 240. This may occur when the user has switched a gripping location, thus changing the point of contact 280. As the point of contact 280 changes, the target position 270 may also change.

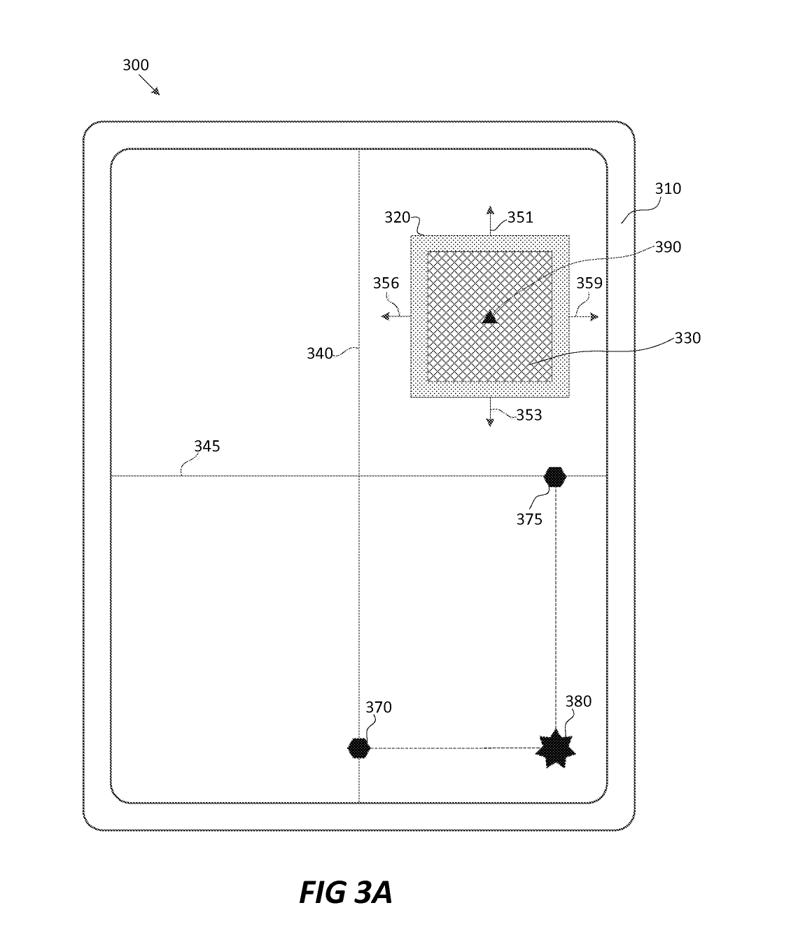

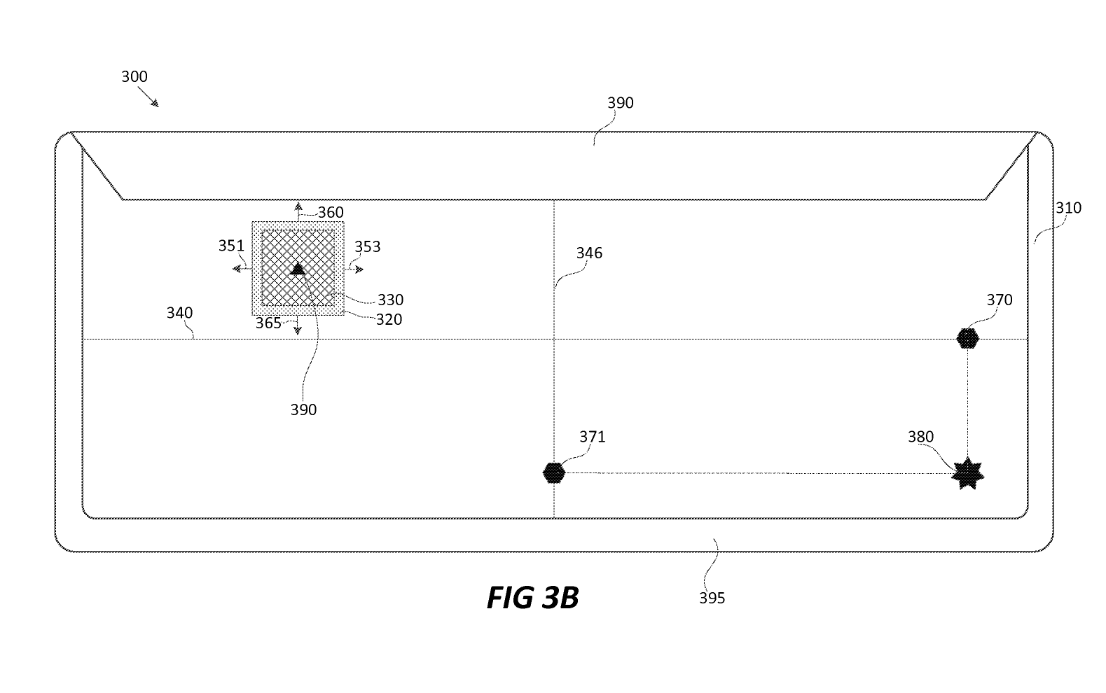

FIG. 3A is a schematic diagram of an example of the felt weight reduction system according to various embodiments. In particular, FIG. 3A illustrates a 2-dimensional implementation of the felt weight reduction system as viewed from a front face (e.g., from the screen display) of a mobile device 300. Now referring to FIGS. 1-3A, an example of a component collection 320 (e.g., such as, but not limited to, the component collection 120) may be provided to receive selected hardware component 110 in the component receiving space 330. The component collection 320 may be arranged within sidewalls 310 of the mobile device 300 (e.g., such as, but not limited to, the mobile device 100).

The component collection 320 may be configured for moving along or parallel to a first axis 340, for example, in either a first direction 351 or a second direction 353. The first direction 351 and the second direction 353 may be opposite directions. In addition, the component collection 320 may be configured for moving along or parallel to a second axis 345, for example, in either a third direction 356 or a fourth direction 359. The third direction 356 and the fourth direction 359 may be opposite directions. Each of the third direction 356 and the fourth direction 359 may be orthogonal to each of the first direction 351 and the second direction 353. Accordingly, the component collection 320 may move in any direction having vector components including one or two of the first direction 351, the second direction 353, the third direction 356, and/or the fourth direction 359.

In some embodiments, the first axis 340 may be parallel to at least one sidewall of the sidewalls 310. The second axis 345 may be perpendicular to the at least one sidewall of the sidewalls 310 and parallel to a different sidewall of the sidewalls 310. In various embodiments, the direction in which the component collection 320 moves is determined based on the point of contact 380 as determined by the position sensor 150 (or gravity). The component collection 320 may initially be in an initial position 390. The initial position 390 may correspond to coordinates having a position along the first axis 340 and the second axis 345. The first axis 340 and the second axis 345 may be imaginary axes of the mobile device 300 or a physical axis as defined by rack(s) or rod(s) of the displacement device 160.

In some embodiments, the position sensor 150 may determine that the user is gripping the mobile device 300 at the point of contact 380 in the manner described. The processor of the mobile device 300 may be configured to determine a corresponding target position based on the point of contact 380. In the 2-dimensional context in which the component collection 320 may be configured to move within a plane instead of alone an axis, the target position may be set to be the same as the point of contact 380. For example, target position (e.g., the point of contact 380) may be defined by a first coordinate 370 on the first axis 340 and a second coordinate 375 on the second axis 345. The target position may likewise be adjusted according to the dimensions of the component collection 320. For example, where the target position is too close to the sidewalls 310 for the component collection 320 to move to correspond directly, the target position may be adjusted to be a point further along the first axis 340 and/or the second axis 345 from the sidewalls 310.

The processor of the mobile device 300 may determine a direction of motion, a distance, velocity, and/or the like of the component collection 320. The direction of motion, the distance, the velocity, and/or the like may be determined based on the target position and the initial position 390. In the non-limiting example illustrated in FIG. 3A, the direction of motion may be a direction vector including the second direction 353 and the fourth direction 359.

FIG. 3B is a schematic diagram of an example of the felt weight reduction system according to various embodiments. FIG. 3B illustrates a 2-dimensional implementation of the felt weight reduction system as viewed from a side surface of the mobile device 200. In particular, FIG. 3B illustrates a moving the component collection 320 parallel to the first axis 340 and/or a third axis 346. Accordingly, embodiments described with respect to FIG. 3A may be combined with embodiments described with respect to FIG. 3B to allow the component collection 320 to move in a 3-dimensional space as defined by the first axis 340, the second axis 345, and the third axis 346. Thus, the diagram of FIG. 3B may present a side view of the system as presented by FIG. 3A.

Now referring to FIGS. 1-3B, the felt weight reduction system illustrated may also include the component collection 320 to receive selected hardware component 110 in the component receiving space 330 in the manner described. The component collection 320 may be arranged between the display screen 390 (e.g., such as, but not limited to, the display screen 130) and an outer back shell 395 of the mobile device 300. The outer back shell 395 may be coupled to or continuous with respect to the sidewalls 310. The component collection 320 may be configured to move parallel the first axis 340 and/or parallel to the third axis 346 in a first direction 351, a second direction 353, a fifth direction 360, a sixth direction 365, a combination thereof, and/or the like. The component collection 320 may be in the initial position 390.

Similar to described herein, the point of contact 380 may be determined by the processor of the mobile device 300 based on data outputted from the position sensor 150. A corresponding target position may be determined by the processor of the mobile device 200. The target position may be set to be the same as the point of contact 380. For example, target position (e.g., the point of contact 380) may be defined by a first coordinate 370 on the first axis 340 and a third coordinate 371 on the third axis 346.

In various embodiments, the initial position 390 of the component collection 320 may be in the center of the first axis 340, the second axis 345, and the third axis 346. The position of the component collection 320 may be reset to the center when the mobile device 300 is powered down and/or when it enters an idle mode in which the mobile device 300 is not being actively used by the user. The initial position 390 of the component collection 320 may be in the center when the mobile device 300 is powered on, transitioned to an active mode from an idle mode, and/or the like. In other embodiments, the initial position 390 may be a position other than the center given that when the user has switched a gripping location, thus changing the point of contact 380. As the point of contact 380 changes, the target position may also change.

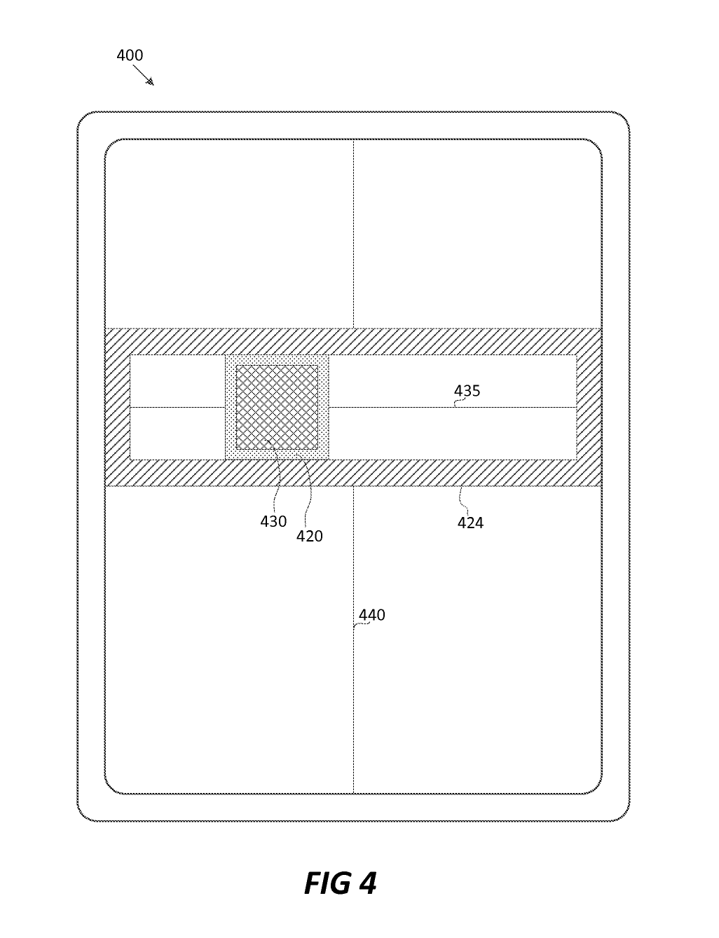

FIG. 4 is a schematic diagram of an example of the felt weight reduction system according to various embodiments. Now referring to FIGS. 1-4, FIG. 4 illustrates a 2-dimensional implementation of the felt weight reduction system as viewed from a front surface (e.g., from the screen display 130) of a mobile device 400. An example of a modular system for moving a component collection 420 (e.g., such as, but not limited to, the component collection 120, 220, 320) may be provided to receive selected hardware component 110 in the component receiving space 430 (e.g., such as, but not limited to, the receiving space 230, 330).

In some embodiments, the component collection 420 may be arranged within or on a secondary collection 424. The component collection 420 may be may be configured to move along or parallel to a primary axis 435. The secondary collection 424 may receive the component collection 420. The secondary collection 424 may also receive any driving mechanisms for driving the component collection 420 along or parallel to the primary axis 435. The secondary collection may be configured to move along a secondary axis 440. The secondary axis 440 may be perpendicular to the primary axis 435. Accordingly, the component collection 420 may be configured to move to any position defined by the primary axis 435 and the secondary axis 440, subject to the limitation of the casing of the mobile device 400, the placement of the display screen 130, the fixed hardware component 140, the position sensor 150, the displacement device 160, the unselected hardware component 170, and/or the like.

In further embodiments, a tertiary collection (not shown) may receive the secondary collection 424 (which includes at least the component collection 420 and driving mechanisms for driving the component collection 420 along or parallel to the primary axis 435). The tertiary collection may be configured to move along a tertiary axis (not shown). The tertiary axis may be perpendicular to both the primary axis 435 and the secondary axis 440. Accordingly, the component collection 420 may be configured to move to any position defined by the primary axis 435, the secondary axis 440, and the tertiary axis (i.e., in a 3-dimensional space).

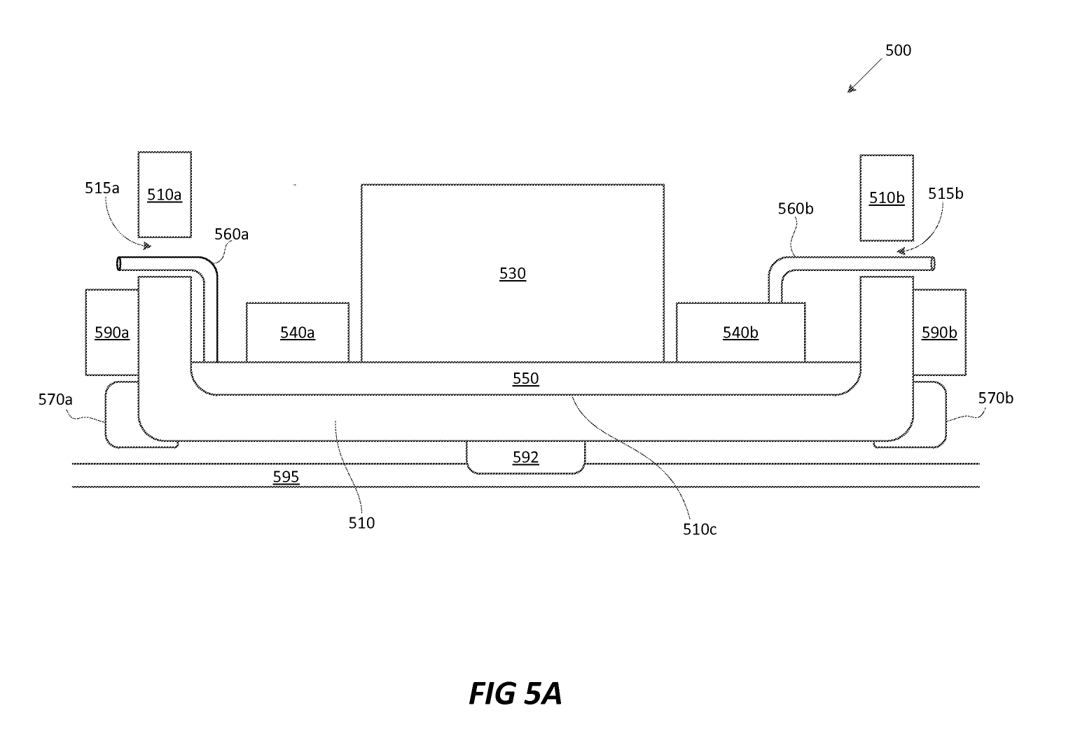

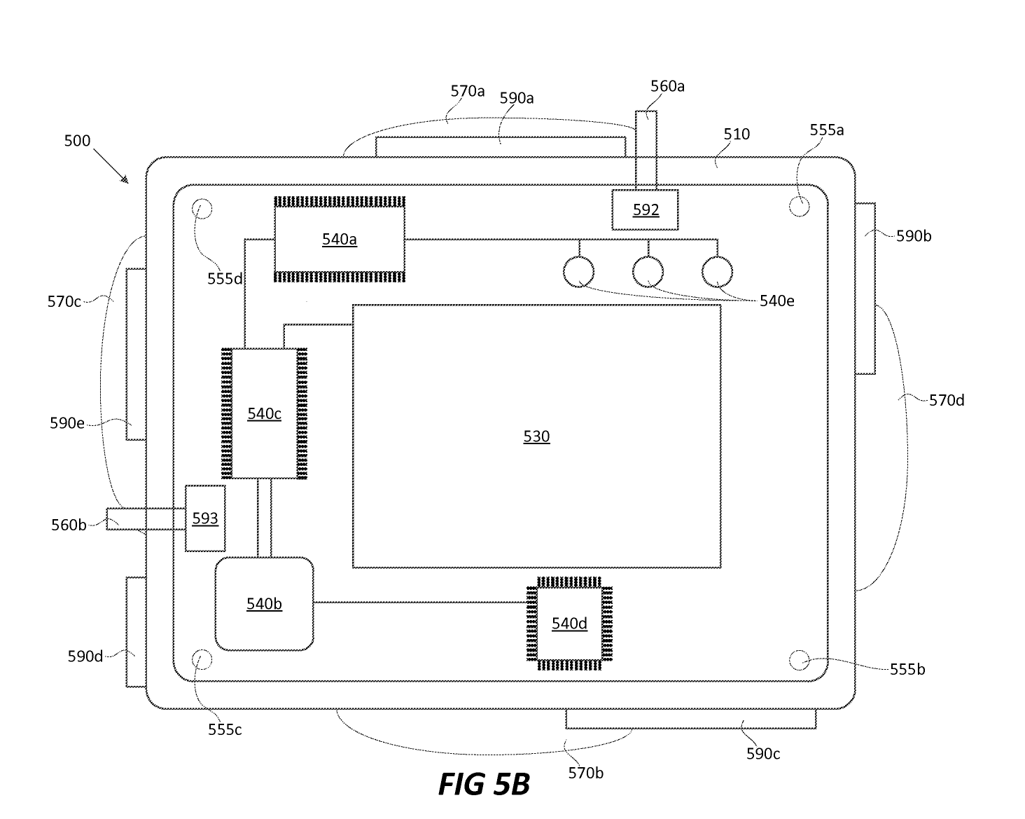

FIG. 5A is a schematic diagram of an example of a component collection according to various embodiments. Now referring to FIGS. 1-5A, an example of a component collection module 500 may be presented in a cross-section view. The component collection module 500 may include at least a component collection 510 such as, but not limited to, the component collection 120, 220, 320, 420. The component collection 510 may be a compact casing, box, platform, or plate for receiving at least one selected hardware component 110. The component collection 510 may include one or more sidewalls. In the non-limiting example of FIG. 5A, a first side wall 510a and a second side wall 510b may be arranged substantially perpendicular to a base plate 510c of the component collection 510. In other embodiments, no sidewalls may be present.

The component collection 510 may receive the selected hardware component 110. A PCB 550 may be secured or otherwise fixed to the base plate 510c of the component collection 510. Various selected hardware components 110 such as the first hardware component 540a and the second hardware component 540b may be received on the PCB 550. Each of the first hardware component 540a and the second hardware component 540 may be a selected hardware component 110 as described. In some embodiments, the battery pack 530 may be arranged on the base plate 510c directly (i.e., the battery pack 530 may not be received on the PCB 550). In other embodiments, at least a portion of the battery pack 530 may be received on the PCB 550. In various embodiments, the battery pack 530 may be located in a substantial center of the component collection 510.

Various connection wires such as a first wire 560a and a second wire 560b may connect the selected hardware component 110 to at least one of the display screen 130, the fixed hardware component 140, the position sensor 150 (e.g., when it is not received in the component collection 510), the displacement device 160, and the unselected hardware component 170. For example, the first wire 560a may be connected to the PCB 550, and the second wire 560b may be connected to the second hardware component 540b. The component collection 510 may include at least one aperture (such as the first aperture 515a and the second aperture 515b) for allowing the inside of the component collection 510 to communicate with the outside. In particular, the wires (e.g., the first wire 560a and the second wire 560b) may be allowed to pass through the at least one aperture. In the non-limiting example illustrated by FIG. 5A, the apertures may be located on the sidewalls (e.g., the first sidewall 510a and the second sidewall 510b). In other examples, the apertures may be located in any suitable location, such as, but not limited to, the base plate 510c, other sidewalls (not shown), a lid (not shown) of the component collection 510, a combination thereof, and/or the like.

In some embodiments, the component collection 510 may include at least one driver coupler 592 configured to be coupled to a driving portion 595 (e.g., the displacement device 160) for moving the component collection 510. In some embodiments, the driver coupler may include at least one a pinion, a solenoid, gear, strings, springs, dampers, a combination thereof, and/or the like. The portion of the driving portion 595 may be a rack, a rod, a guide, a combination thereof, and/or the like.

Furthermore, the component collection 510 may include at least one heat sink (e.g., a first heat sink 590a, a second heat sink 590b, and/or the like) for dissipating heat within the component collection 510. The at least one heat sink may be arranged on any outer surface of the component collection 510 including the sidewalls (e.g., the first side wall 510a and the second sidewall 510b), the base plate 510c, a top plate (not shown), and/or the like. In other embodiments, one or more the at least one heat sink may be arranged within the component collection 510. The component collection 510 may also include dampers (e.g., the first cushion 570a and the second cushion 570b) for damping/cushioning the motion of the component collection 500a.

FIG. 5B is a schematic diagram of an example of a component collection according to various embodiments. Now referring to FIGS. 1-5B, an example of a component collection module 500 may be presented in a top view (e.g., as seen from the display screen 130). The component collection module 500 may include at least a component collection 510 such as, but not limited to, the component collection 120, 220, 320, 420. The component collection 510 may include one or more sidewalls, which may form a substantially square, rectangular, or other suitable shapes when viewed from the top view. In some embodiments, the sidewalls are arranged along each side of the component collection 510. The sidewalls may be arranged along some sides of the component collection 510 but not others.

A PCB 550 may be secured or otherwise fixed to the base plate (not shown) of the component collection 510 through fixing members such as a first fixing member 555a, a second fixing member 555b, a third fixing member 555c, and a fourth fixing member 555d. Each of the fixing members may be a nail, screw, glued surface, plug, soldering, a combination thereof, and/or the like. Various selected hardware components 110 may be received on the PCB 550 and/or directly on the base plate. The first hardware component 540a (e.g., a first microchip), the second hardware component 540b (e.g., a processor), a third hardware component 540c (e.g., a second microchip), a fourth hardware component 540d (e.g., a third microchip), and a fifth hardware component 540e (e.g., batteries and/or capacitors) may be received on the PCB 550. The battery pack 530 may be received on the PCB 550 or the base plate directly. In various embodiments, the battery pack 530 may be located in a substantial center of the component collection 510.

Various connection wires such as the first wire 560a and the second wire 560b may connect the selected hardware component 110 to at least one of the display screen 130, the fixed hardware component 140, the position sensor 150 (e.g., when it is not received in the component collection 510), the displacement device 160, and the unselected hardware component 170. Various hubs such as the first hub 592 and the second hub 593 may be configured to receive various wires (e.g., from different selected hardware components 110) for directing the wires through the apertures (e.g., the first aperture 515a, the second aperture 515b, and/or the like). Accordingly, the hubs may be arranged on the PCB 550 or on the base plate 510c. The hubs may be proximal to the apertures (e.g., closer to the apertures than at least one selected hardware component 110).

Furthermore, the component collection 510 may include at least one heat sink (e.g., the first heat sink 590a, the second heat sink 590b, a third heat sink 590c, a fourth heat sink 590d, a fifth heat sink 590e, and/or the like) for dissipating heat within the component collection. The at least one heat sink may be received on an outer surface of a sidewall (e.g., the first sidewall 510a and the second sidewall 510b). The component collection may also include dampers (e.g., the first cushion 570a, the second cushion 570b, a third cushion 570c, and a fourth cushion 570d, and/or the like) for damping the motion of the component collection 500. The dampers may be received on an outer surface of a sidewall (e.g., the first sidewall 510a and the second sidewall 510b). In further embodiments, sound dampers may be added to eliminate or otherwise reduce the sound that the driving system makes while moving the component collection.

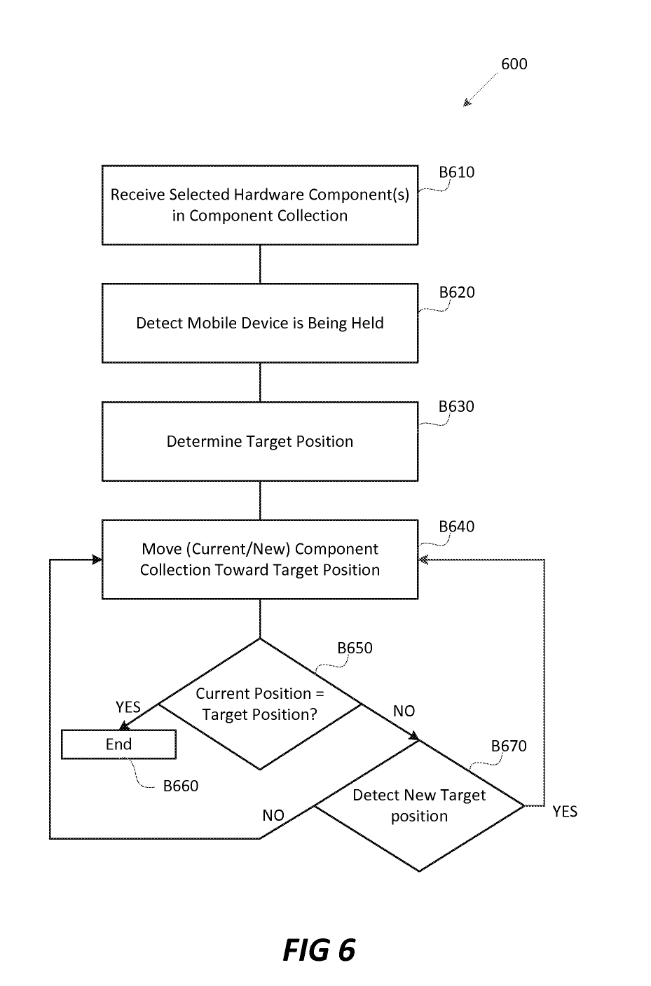

FIG. 6 is a process flowchart illustrating a process 600 for moving a center of mass of a mobile device according to various embodiments. With reference to FIGS. 1-6, at block B610, at least one selected hardware component 110 may be received in a component collection 120 (e.g., the component collection 220, 320, 420, 424, 510). The selected hardware component 110 may be selected from various hardware components (e.g., from the selectable components) in the manner described. The selected hardware component 110 may be arranged in the component collection 120 as described. Dampers (e.g., springs, high-friction surfaces, strings, stoppers, and/or the like) and heat sinks may be provided to the component collection 120. Apertures may be provided to the component collection 120 to provide communication for the connection wires/cables in the manner described. Additional apertures and heat sinks may be provided on the component collection 120 to dissipate and/or control heat.

Next at block B620, the processor of the mobile device 100 may determine or otherwise detect that the mobile device may be held by the user. In some embodiments, the mobile device 100 may be determined to be held when the mobile device 100 is in active use by the user (e.g., when the mobile device 100 is accepting user input via the display screen 130 and/or other suitable user input device). The mobile device 100 may be determined to be held when the mobile device is in an active mode (e.g., when the mobile device 100 is in a screen-locked and/or screen-off mode).

Next at block B630, the processor of the mobile device 100 may determine or otherwise detect a point of contact of the user. The point of contact may be determined based on various sensor output data as described herein. The point of contact may be associated with a coordinate in a 1-dimensional, 2-dimensional, or 3-dimensional space (e.g., corresponding to the component collection 120 being able to move within the 1-dimensional, 2-dimensional, or 3-dimensional space).

In the embodiments where the component collection 120 may be passively driven by gravity (e.g., the component collection 120 may be configured for free motion subject to damping, cushioning, and the like), the mobile device 100 may not need to be configured to detect whether the mobile device 100 is being held (e.g., as set forth with respect to block B620) and/or detect the point of contact (e.g., as set forth with respect to block B630).

Next at block B640, the component collection 120 may be moved toward the point of contact. For example, the component collection 120 may be moved with the displacement device 160 in the manner described. In some embodiments, the displacement device 160 may be configured to drive the component collection 120 toward the point of contact (e.g., a target position determined based on the point of contact in the manner described). The displacement device 160 may be suitable mechanisms such as, but not limited to, a rack/pinion system, solenoid/rod system, gravity, a combination thereof, and/or the like. The displacement device 160 may actively drive the component collection 120 (e.g., with a motor). The displacement device 160 may passively drive the component collection 120 (e.g., by providing controlled free motion in the manner described). In some embodiments, the mobile device 100 may store computer-readable instructions in the memory of the mobile device 100 for the functions described above.

Next at block B650, the processor of the mobile device 100 may determine the current position of the component collection 120 is the same as the point of contact (e.g., with a processor of the mobile device 100). The processor may compare the coordinate of the current position of the component collection 120 with the target position. If the current position of the current position of the component collection 120 is at the target position, the next at block B660 (B650:YES), the processor ends.

On the other hand, if the current position of the current position of the component collection 120 is not at the target position, the next at block B670 (B650:NO), the processor may determine whether a new target position is determined. In some embodiments, the sensors of the mobile device 100 may detect new target position that is not the same as the previous target position (the previous target position defining the position toward which the component collection 120 may be moving toward). Whereas, no new target position is determined, the displacement device 160 may be configured to move the component collection 120 further toward the current target position, back to block B640 (B670:NO).

Upon receiving the new target position, the processor may configure the displacement device 160 to move the component collection 120 toward the new target position, back to block B640 (B670:YES).

In should be appreciated by one of ordinary skill in the art that the foregoing description may be applicable to any handheld electronic devices to reduce the felt weight of those devices.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Alternatively, some steps or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to some embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. An apparatus in a mobile device, the apparatus comprising:
a component collection having at least one selected hardware component of the mobile device; and
a sensor configured to provide a signal corresponding to a position on the mobile device where a user would grip the mobile device;
wherein the component collection is configured for movement within an interior volume of a casing of the mobile device based, at least in part, on the signal provided by the sensor.

2. The apparatus of claim 1, wherein the at least one selected hardware component comprises at least one of: a processor, memory device, battery, wireless radio, or printed circuit board (PCB).

3. The apparatus of claim 1, wherein:
at least one damper is coupled to the component collection; and
the damper is configured to decelerate and stabilize motion of the component collection.

4. The apparatus of claim 3, wherein each of the at least one damper comprises at least one of a spring, high-friction surface, string, or stopper.

5. The apparatus of claim 1, wherein the sensor comprises at least one of a gravity sensor, heat sensor, display screen, or accelerometer.

6. The apparatus of claim 1, further comprising a displacement device, wherein the displacement device is configured to move the component collection in response to the signal provided by the sensor.

7. The apparatus of claim 1, wherein the displacement device comprises at least one of a rack and pinion system or solenoid system.

8. The apparatus of claim 7, wherein the displacement device actively drives the component collection with at least one motor.

9. The apparatus of claim 1, wherein the component collection is supported within the casing for movement by gravity.

10. The apparatus of claim 1, wherein:
the component collection is supported in the casing for movement in a first direction along a first axis; and
the component collection is supported in the casing for movement in a second direction along a second axis, wherein the second axis is perpendicular to the first axis.

11. The apparatus of claim 10, wherein the component collection is supported in the casing for movement in a third direction along a third axis, wherein the third axis is perpendicular to both the first axis and the second axis.

12. A mobile device comprising:
a casing defining an interior volume;
a component collection having at least one selected hardware component of the mobile device;
a displacement device configured to move, with respect to the casing of the mobile device, the component collection to a point of contact, wherein the point of contact corresponds to where a user would grip the mobile device; and
at least one fixed hardware component, wherein the at least one fixed hardware component is fixed with respect to the casing.

13. The mobile device of claim 12, further comprising a display screen and an outer back shell arranged opposite to the display screen, wherein the component collection is configured to move between the display screen and the outer back shell.

14. The mobile device of claim 13, wherein the at least one selected hardware component is connected to the at least one fixed hardware component and the display screen with at least one cable.

15. The mobile device of claim 12, wherein the component collection is supported within the casing for movement by gravity.

16. The mobile device of claim 12, wherein the displacement device may be configured to support moving of the component collection to a bottom portion of the mobile device.

17. The mobile device of claim 12, further comprising a sensor configured to output a signal corresponding to the point of contact, wherein the displacement device is configured to move the component collection in response to the signal.

18. A method for reducing a felt weight of a mobile device, the method comprising:
determining, with a processor of the mobile device, a first target position, wherein the first target position is where a user would grip the mobile device; and
configuring a component collection to move within an interior volume of the mobile device to the first target position.

19. The method of claim 18, further comprising providing the component collection having at least one selected hardware component, wherein the selected hardware component comprises a battery.

20. The method of claim 18, wherein:
the component collection is configured to move based on information detected by at least one sensor; and
the at least one sensor comprises at least one of a gravity sensor, heat sensor, display screen, or accelerometer.
